(19) United States
(12) Patent Application Publication
(10) Pub. No.: US 2009/0077368 A1
(43) Pub. Date: Mar. 19, 2009

(54) Controller for a Mass Memory and Method for Providing Data for a Start Process of a Computer

(76) Inventor: Robert Depta, Augsburg (DE)

Correspondence Address: SLATER & MATSIL, L.L.P., 17950 PRESTON RD, SUITE 1000, DALLAS, TX, 75252-5793, US

(21) Appl. No.: 12/212,211

(22) Filed: Sep. 17, 2008

(30) Foreign Application Priority Data
Sep. 17, 2007 (DE) 10 2007 044 199.3

(51) Int. Cl. G06F 9/24

(52) U.S. Cl. 713/2

(57) ABSTRACT

In the process for providing data for a start process of a computer by a controller (3) for a mass memory (7), the following steps are executed. Data that was initially read from the mass memory during a first start process (e.g., booting) of the computer is identified by the controller (3). During a subsequent shutdown of the computer, at least one part of the identified data is copied by the controller (3) from the mass memory (7) to a non-volatile buffer memory (5) of the controller. In another subsequent start process of the computer, at least one part of the data read during this start process of the computer is provided from the non-volatile buffer memory (5).

This application claims priority to German Patent Application 10 2007 044 199.3, which was filed Sep. 17, 2007 and is incorporated herein by reference.

### TECHNICAL FIELD

Embodiments of the invention relate to a method for providing data for a start process of a computer by a controller for a mass memory and also to a controller for a mass memory suitable for executing the process.

### BACKGROUND

For the start process of a computer after the computer is turned on (cold start) or after the computer is reset (warm start), initially a start routine, which is stored in a non-volatile memory, for example, an EEPROM (Electrically Erasable Programmable Read-Only Memory) or a flash memory, of a BIOS (Basic Input-Output System) of the computer is typically processed. This start routine first initializes the loading of additional parts of the BIOS from the non-volatile memory as well as possible supplements to the BIOS and device drivers from a mass memory, for example, a magnetic hard-disk drive. Then, parts of an operating system, which are then to be executed on the computer, are loaded from the mass memory. This start process, also called booting or powering-up the computer, can take from tens of seconds up to minutes.

A method for accelerating the start process is known from the VISTA operating system by Microsoft in connection with the use of so-called hybrid hard-disk drives. In addition to a magnetic hard-disk memory, such hybrid hard-disk drives also have a non-volatile flash memory. After power is supplied, a magnetic hard-disk memory can be used only after its rotating magnetic disks have been brought to the operating rotational speed. This waiting time is eliminated for a non-volatile memory using flash technology. In the VISTA operating system, it is possible to divide files of the operating system onto the two different parts of a hybrid hard-disk drive, wherein, the files to be loaded first during a start process of the operating system are provided on the non-volatile flash memory, which is ready to use sooner. However, this process requires the use of a hybrid hard-disk drive. Furthermore, the method is possible only for an operating system installed accordingly.

### SUMMARY

In one aspect, embodiments of the present invention create a process for accelerating the start process of a computer, which is independent of the operating system that is used. In another aspect, embodiments of the invention create a controller that is suitable for executing the process for a mass memory.

According to a first embodiment, a process provides data for a start process of a computer by a controller for a mass memory, which features the following steps. First, data that is to be read from the mass memory during a first start process (booting) of the computer is identified by the controller. When the computer is subsequently turned off, also called shutdown, at least one part of the identified data is copied by the controller from the mass memory into a non-volatile buffer memory of the controller. For another subsequent start process of the computer, at least one part of the data read during the start process of the computer is provided to the computer from the non-volatile buffer memory.

Therefore, because at least one part of the data read during the further start process of the computer has been read from the non-volatile buffer memory, which is ready to use sooner after a start-up than the mass memory, a time advantage is generated for each additional start process. This time advantage is produced not only for files of an operating system to be loaded during the start, but also for supplements to the BIOS or driver components to be loaded from mass memory in the scope of the BIOS. The identification of the data read by the computer during the start process of the computer and also the copying of this data into the non-volatile buffer memory are performed by the controller of the mass memory. Thus, the process can be executed completely independently of assistance from the operating system or the BIOS. It is transparent for the operating system and can be used accordingly in any operating system.

According to the advantageous constructions of the process, the data read during the start process of the computer is identified with reference to filenames and/or paths or designations or addresses of the memory units, in which the data is stored in the mass memory. Both alternatives are suitable for unique identification of the data and guarantee that the data needed for the start process is copied into the non-volatile buffer memory and is provided accordingly by this memory. In an especially preferred way, in the last named alternative, these memory units are sectors or clusters of the mass memory.

In another advantageous construction of the process, after the step of identifying the data, a list of the identified data is created and the data is copied from the mass memory into the non-volatile buffer memory with reference to this list. Preferably, this list is updated during the subsequent start process of the operating system. In this way, adaptation to modified procedures of the start process, for example, after an installation of new devices or supplements to the operating system, is guaranteed at all times.

According to a second aspect of the present invention, the task is achieved by a controller for at least one mass memory, wherein the controller has a non-volatile buffer memory for data of the one or more mass memories and a controller for the non-volatile buffer memory. The controller is here suitable for executing one of the processes named above. Preferably, the controller is suitable for controlling mass memories in a RAID (Redundant Array of Independent Devices) arrangement. The advantages of the second aspect correspond to those of the first aspect.

### BRIEF DESCRIPTION OF DRAWINGS

The invention will be explained in more detail below using embodiment examples with the aid of two figures.

FIG. 1, a schematic drawing of a computer with a controller with non-volatile buffer memory and a mass memory; and

FIG. 2, a flow chart of a process for starting a computer.

The following list of reference symbols can be used in conjunction with the drawings:

1 Main circuit board

2 Data connection

3 Controller

4 Control unit

5 Non-volatile buffer memory

6 Further data connection

7 Mass memory

8 Data region

9 Data

10 Meta-data region

11 List

### DETAILED DESCRIPTION OF ILLUSTRATIVE EMBODIMENTS

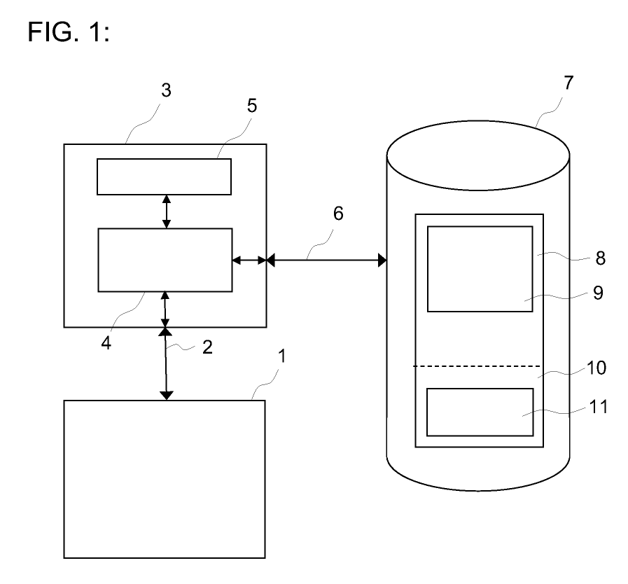

FIG. 1 shows a computer comprising a main circuit board 1, which is connected to a controller 3 by means of a data connection 2. The controller 3 has a control unit 4 and a non-volatile buffer memory 5 connected to this control unit. The controller 3 is connected to a mass memory 7 by means of a further data connection 6. In the mass memory 7, a data region 8 is provided with data 9 and a meta-data region 10 is provided with a list 11.

In FIG. 1, only the components of the computer relevant for the subject matter of the application are shown. Other components, such as, for example, power supply units for the main circuit board 1, the controller 3, and the mass memory 7 are left out for better clarity.

The controller 3 and the mass memory 7 can be arranged in one housing together with the main circuit board 1. In such a case, the controller 3 is frequently constructed as a plug-in card for insertion into the main circuit board 1 and the data connection 2 between the main circuit board 1 and the controller 3 corresponds to the PCI (Peripheral Component Interface) or the PCI-Express specification. It is also possible to integrate the controller 3 and the mass memory 7, not with the main circuit board 1 in one computer housing, but rather to construct it as an external unit in a separate housing. In such a case, an Ethernet or Fiber Channel connection is provided as a data connection 2 between the main circuit board 1 and the controller 3. In such a case, the unit made from the controller 3 and one or more mass memories 7 is also designated as NAT (Network Attached Storage).

In the embodiment shown, the mass memory 7 is a magnetic hard-disk drive, whose memory area is divided into the data region 8 and the meta-data region 10. All known connections, such as, for example, IDE-ATA (Integrated Disc Electronics-Advanced Technology Attachment), SATA (Serial Advanced Technology Attachment), or SAS (Serial Attached Small Computer System Interface), or FC (Fiber Channel) can be used as the further data connection 6 between the controller 3 and the mass memory 7. It is also possible that, for the mass memory 7, a unit is provided for converting the type of connection, so that Ethernet or iSCSI (internet Small Computer System Interface) could also be used, for example, as the further data connection 6, wherein the mass memory 7 itself is tied to one of the named types (IDE-ATA, SATA, SAS, etc.). An adaptation of the controller 3 to future standards for controlling mass memories is also conceivable. The details of the construction of the mass memory 7 is not significant for the process according to the invention. All that is important is that the non-volatile buffer memory 5 provided in the controller 3 is ready to use sooner after the computer is turned on than the mass memory 7. This can be assumed, however, for mass memories 7 with moving components, in particular, for magnetic hard-disk drives.

In the embodiment of FIG. 1, the controller 3 is connected only to the mass memory 7. However, it can also be designed for the connection of several mass memories 7, optionally in the form of a RAID (Redundant Array of Independent Devices) controller. In the last named case, the controller 3 can also be designed to store data stored on the mass memory 7 according to the “Common Rate Disk Data Format Specification” of SNIA (Storage Networking Industry Association). According to this specification, for a mass memory 7 or a partition of a mass memory 7, in addition to the data region 8, there is also the meta-data region 10, which is provided for storing information that the controller 3 uses for managing the mass memory 7.

As the non-volatile buffer memory 5, either battery-backed static or dynamic memory cells are used or non-volatile memory cells based on flash technology are used. For the non-volatile buffer memory 5, a size of at least approximately 10 MB (megabyte), but better at least approximately 100 MB, is useful to be able to provide sufficient storage capacity for data of the start process. Furthermore, the memory should be ready to use within a very short time after power is supplied.

It is possible that the non-volatile intermediate buffer memory 5 in the controller 3 is provided especially for the process according to an embodiment of the invention. However, in controllers for mass memories in a RAID configuration, it is also known to provide a fast buffer memory (cache), in order to write data onto the mass memory or to buffer data to be read from this mass memory. Frequently, such a buffer memory is designed as a non-volatile memory, in order to guarantee if power is lost that data not yet written onto the mass memory and present only in the fast buffer memory is not lost. In addition to its use for the process according to an embodiment of the invention, this task can also be taken over suitably by the non-volatile buffer memory 5. In such a case, when the non-volatile buffer memory 5 is also used accordingly as a fast buffer memory for data (data cache), the use of memories with fast access times and high data rates is meaningful. In particular, the use of battery-backed static or dynamic memory cells is then provided.

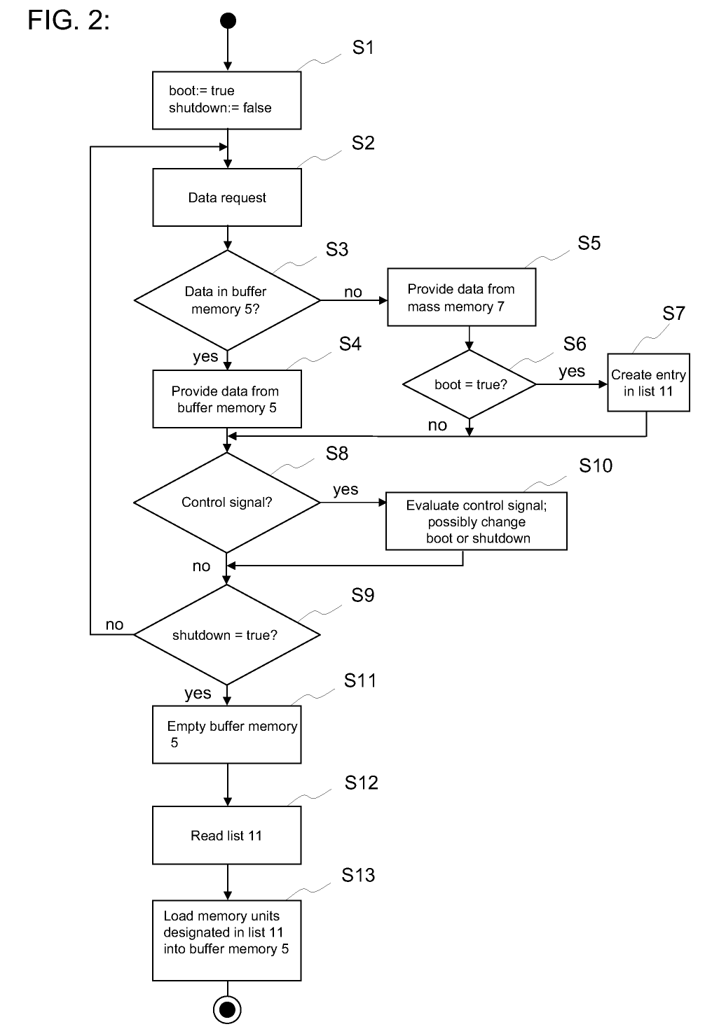

Below, an embodiment of the process according to an embodiment of the invention, which is executed, for example, by an arrangement as shown in FIG. 1, will be described in more detail in connection with FIG. 2. Reference symbols indicated in FIG. 2 and in the following description refer accordingly to FIG. 1.

The process shown schematically in the form of a flow chart in FIG. 2 starts when power is supplied after the computer comprising the main circuit board 1, the controller 3, and the mass memory 7 is turned on.

In a first step S1, two flags (also called markers) are defined in the controller 3 that are used for further control of the procedure. The first flag “boot” indicates whether the computer is in the start phase. This flag is set in step S1. The second flag “shutdown” indicates whether the operating system of the computer is in the shutdown phase for preparing for the subsequent turning-off of the computer. This flag is reset in step S1.

In a next step S2, data from the mass memory 7 is requested by the main circuit board 1 of the computer. If the computer was previously turned on, then this data involves data required in connection with the start process of the computer.

In a next step S3, the control unit 4 of the controller 3 checks whether the requested data is possibly already located in the non-volatile buffer memory 5 of the controller 3. If this is the case, then in step S4 the requested data is provided to the main circuit board 1 from the non-volatile buffer memory 5 via the data connection 2.

If it was determined in step S3 that the requested data is not located in the non-volatile buffer memory 5, the process branches to a step S5, in which the requested data is read from the mass memory 7 and provided to the main circuit board 1 via the data connection 2. This procedure corresponds to that of a “cache miss” for a data cache.

In the subsequent step S6, it is determined with reference to the flag “boot” whether the computer is located in the power-up phase. If this is the case, then in step S7, the numbers or addresses of the memory units in which the requested data is stored on the mass memory 7 are recorded in the list 11. The memory units can be, for example, sectors, clusters, or other memory regions of the mass memory 7 into which this mass memory is divided physically or logically.

In this way, it is provided that the list 11 is stored in the meta-data region 10 of the mass memory 7. Alternatively, the list 11 can also be stored in the data region 8, if, for example, no designated meta-data region 10 is provided in the mass memory 7. It is also possible to store the list 11 in a non-volatile memory within the controller 11 itself, for example, also in the non-volatile buffer memory 5.

If the list 11 does not exist at the provided memory location, for example, when the process is executed for the first time, it is constructed accordingly in step S7. It is possible that the data to be written is written directly into the list 11 at its storage location. It is also possible that an already existing list 11 is read at the beginning of the process in step S1 into a working memory of the controller 3 or the control unit 4 and that the list 11 in the working memory is expanded in step S7. After completion of the start process, the list 11 can then be transmitted from the working memory to its provided memory location.

After one of the steps S4, S6, or S7 has been executed, the process continues with step S8. In this step, it is asked whether control information is transmitted from the main circuit board 1 to the controller 3. Such control information can be output, for example, by a (software) driver component for the controller 3. For executing the method shown, it is provided, in particular, that a driver component loaded by the operating system is set up for the controller 3 so that it signals the end of the start sequence and the beginning of the phase of shutting down the operating system to the controller 3. This information is typically provided within each operating system and can be read and forwarded accordingly from the operating system-specific driver component.

In the flow chart of FIG. 2, receipt of control information (step S8) occurs after the data preparation (steps S4 and S5). It is also possible to execute the transmission of control information (quasi-) parallel to the data preparation. The reception of control information can then be controlled, for example, by means of an interrupt mechanism or a similar signaling mechanism between the main circuit board 1 and the controller 3.

If no control information is received in step S8, the process continues in step S9, in which the flag “shut down” is evaluated. If this flag is not set, the process branches back to step S2, so that the controller 3 is ready to provide additional data upon request.

In step S8, if control information is received, this is evaluated in a step S10. If the control information indicates that the start process has ended, then the flag “boot” is reset. If the list 11 was expanded in the working memory of the controller 3, it can now be written to its provided memory location, for example, the meta-data region 10 of the mass memory 7. Furthermore, it can be provided to empty the non-volatile buffer memory 5, particularly if the non-volatile buffer memory 5 is also used as a data cache. At this point in time, data provided in the non-volatile buffer memory 5 is that of the boot process, which will, in all likelihood, not be subsequently required. However, emptying of the non-volatile buffer memory 5 is not absolutely required, especially if typical and known mechanisms that are therefore not described in more detail here are used for the dynamic removal of unneeded data from a data cache.

If the control information evaluated in step S10 signals the beginning of the shutdown phase, in step S10 the flag “shut down” is set.

In step S10, if the flag “shut down” has been set, the process branches in the subsequently executed step S9 to a step S11. If the non-volatile buffer memory 5 is also used as a data cache, in this step S11, all of the data present in the non-volatile buffer memory 5 and until now not yet written to the mass memory 7 is now written to the mass memory 7 (so-called cache flush). If the non-volatile buffer memory 7 is used exclusively for storing data of the boot process, step S11 can be eliminated.

In the subsequent step S12, the list 11 is read from the mass memory 7 by the controller 3. In the following step S 13, the memory units listed in the list 11, for example, sectors or clusters, are transmitted from the mass memory 7 into the non-volatile buffer memory 5. These memory units contain data that is needed during the start process of the computer. If the non-volatile buffer memory 5 has sufficient memory space, the data of all of the memory units listed in the list 11 is transmitted. If the non-volatile buffer memory 5 either has insufficient capacity or a part of its capacity is still taken up by data that could not be written to the mass memory 7 in step S11, then the list 11 is processed as much as possible. Therefore, in the list 11, it is advantageous to list the sectors in the sequence in which they were requested during the boot process, so that the data first required during the boot process can be transferred with priority into the non-volatile buffer memory 5. After step S13, the process ends. Here, it can be provided to signal the completion of the process to the main circuit board 1, so that this circuit board can instruct the power supply of the computer to be turned off.

Steps S11 and S13 have the effect that, for a new start process of the computer and, accordingly, a new execution of the process shown in FIG. 2, all data requested in step S2 in the start process, or at least a large portion of it, is located in the non-volatile buffer memory 5 and can be provided in step S4 to the main circuit board 1 of the computer in a correspondingly fast way. If, for example, due to changes to the hardware or software configuration, not all of the data of the start process is located in the non-volatile buffer memory 5, this is noted in step S3 with reference to the “cache miss” and the list 11 is automatically updated in steps S6 and S7. In addition, for an update, it can be provided that the numbers or addresses of memory units that are indeed contained in the list 11 but are not needed during the start process are again deleted from the list 11. In another implementation of the process, it can be provided that the numbers of addresses of memory units are deleted from the list 11 only when these are not needed in several successive start processes.

In addition to the identification of the required data mentioned in the embodiment with reference to the numbers or addresses of memory units, for example, sectors or clusters, it can also be provided to use file paths and names for identifying the data. However, the use of numbers or addresses of sectors or clusters has proven especially advantageous when the non-volatile buffer memory 5 is also used as a fast data cache, because such a memory is typically already designed to buffer data on the basis of sectors or clusters.

What is claimed is:

1. A method for providing data for a start process of a computer by a controller for a mass memory wherein the data for the start process of the computer is stored in the mass memory, the method comprising:
identifying data, which was read from the mass memory by the controller during a first start process of the computer;
copying at least one part of the identified data from the mass memory into a non-volatile buffer memory of the controller by the controller during a shutdown process of the computer; and
providing at least one part of the identified data during a subsequent start process of the computer from the non-volatile buffer memory.

2. The method according to claim 1, wherein the first and subsequent start processes of the computer comprise a complete or partial loading of a BIOS and/or an operating system.

3. The method according to claim 1, wherein the data read during the first start process of the computer is identified with reference to filenames and/or paths.

4. The method according to claim 1, wherein the data read during the first start process of the computer is identified with reference to designations of memory units, wherein the data is stored on the mass memory.

5. The method according to claim 4, wherein the mass memory comprises a magnetic hard-disk drive and wherein the memory units comprise sectors or clusters, whereby the magnetic hard-disk drive is divided physically or logically.

6. The method according to claim 1, further comprising, after identifying the data, creating a list of identified data and copying the data from the mass memory into the non-volatile buffer memory with reference to the list.

7. The method according to claim 6, wherein the list is updated during the subsequent start process of an operating system.

8. A controller for at least one mass memory, the controller comprising:
a non-volatile buffer memory that stores data of the at least one mass memory; and
a control unit for the non-volatile buffer memory, the control unit being configured to execute a start process that was stored in the non-volatile memory buffer based on previous execution of the start process.

9. The controller according to claim 8, wherein the at least one mass memory comprises mass memories in a RAID arrangement.

10. The controller according to claim 8, wherein the control unit is further configured to store information on data read during the start process.

11. The controller according to claim 10, wherein the control unit is further configured to store information on data read during the start process of a computer in the non-volatile buffer memory.

12. The controller according to claim 10, wherein the control unit is further configured to store information on data read during the start process of a computer in the at least one mass memory.

13. A computer system comprising:
a main circuit board;
a mass memory; and
a controller for the mass memory, the controller comprising a non-volatile buffer memory and a control unit for the non-volatile buffer memory, the control unit being configured to execute a start process that was stored in the non-volatile memory buffer based on previous execution of the start process.

14. The computer system according to claim 13, wherein the at least one mass memory comprises mass memories in a RAID arrangement.

15. The computer system according to claim 13, wherein the control unit is further configured to store information on data read during the start process.

16. The computer system according to claim 13, wherein the control unit is further configured to store information on data read during the start process of a computer in the non-volatile buffer memory.

17. The computer system according to claim 13, wherein the control unit is further configured to store information on data read during the start process of a computer in the at least one mass memory.
